(19) United States
(12) Patent Application Publication
(10) Pub. No.: US 2004/0172149 A1
(43) Pub. Date: Sep. 2, 2004

(54) Order-based production system

(76) Inventor: Kentaro Eto, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/785,933

(22) Filed: Feb. 26, 2004

(30) Foreign Application Priority Data
Feb. 27, 2003 (JP) 2003-050786

(51) Int. Cl. G06F 19/00

(52) U.S. Cl. 700/95; 705/26

(57) ABSTRACT

An order-based production system (1) provides a user with drawing software through an Internet (NW). A user can design a decoration pattern on a cake by vector graphics using this drawing software. Data output from the drawing software is transmitted to the order-based production system (1) and used for a cake processing performed by a processing device 3. This can facilitate ordering and producing an order-made product having high originality.

### BACKGROUND OF THE INVENTION

1. Field of the Invention

The present invention relates to an order-based production system for producing a product to a user's order. More specifically, the present invention relates to a technique for producing an original product with a pattern designed by a user given thereto.

2. Description of the Related Art

Thanks to the spread of the Internet, services that allow ordering and purchasing order-based products online increase. Japanese Patent Application Laid-Open (JP-A) Nos. 2001-160098, 2002-140579, 2002-157471, and 2002-279239, for example, propose systems for placing orders for original cakes through the Internet.

According to each of the systems disclosed by these patent documents, a user can select a type and a topping of a cake and instruct a destination using an order screen on a homepage or an email. In addition, each of the systems disclosed by JP-A Nos. 2001-160098 and 2002-140579 receives image data from the user, and decorates the cake based on an edible sheet on which an image is printed.

However, only by selecting the type of the cake, the topping, and the like from among options prepared in advance, originality of the cake is low and an appealing effect to the user is not obtained so greatly.

If a method of decorating the cake using the edible sheet is adopted, the originality of the cake is high; however, the following disadvantages arise. First, overall design and appearance of the cake are not so good. A user who does not own mechanical equipment such as a digital camera or a scanner cannot prepare for the image data, so that the user cannot utilize the service. Besides, an advanced skill is required to process the image data (raster graphics). Due to this, a user unfamiliar with computers finds it difficult to prepare an image as the user desires. On a production side, time and labor for the management, processing, and the like of the image data increase, thereby deteriorating productivity.

Not only decorated cakes but also all other order-based products are faced with these disadvantages.

### SUMMARY OF THE INVENTION

The present invention has been achieved in light of these circumstances. It is, therefore, an object of the present invention to provide a technique for realizing an order-based production system that can facilitate ordering and producing an order-based product with high originality.

In order to attain the object, the present invention performs order-based production using the following procedures and means.

The order-based production system includes a processing device that gives a pattern to a product and a computer system that is connected to this processing device. A user who places an order accesses the order-based production system using a user terminal.

The computer system is constructed by one or a plurality of computers. If the computer system is constructed by a plurality of computers, the following processing is performed by a cooperation of the computers. The computer system is connected to one or a plurality of processing devices. The computer system and the processing device(s) may be connected to each other so as to be able to transmit or receive data to or from each other. They are not always disposed at the same location.

When the user accesses the order-based production system, order acceptance means of the computer system allows the user to input order information.

The “order information” means information necessary to order the product, and may include information such as a name, an address, a telephone number, and an email address of the user (orderer), a name, an address, and an email address of a recipient of the product, a reception date, a reception location, a reception method, a settlement method, basic specifications of the product, and the like.

It is preferable that the order acceptance means displays a form screen for inputting order information to the user terminal to urge the user to input the information. For example, if it is assumed that the product is a decorated cake, the order acceptance means may allow the user to input, as the basic specifications of the product, a size, a shape, and a type of the cake, a material used for decoration, and wrapping.

It is also preferable that the order acceptance means performs authentication of the user or the user terminal when the user inputs the order information.

Software providing means of the computer system provides drawing software that can design a pattern given to the product by vector graphics, to the user (user terminal) inputting the order information through an electric communication line. It is thereby possible for the user to acquire the drawing software dedicated to this system and perform a pattern design operation using this drawing software. The software providing means then acquires pattern data output from the drawing software.

The drawing software may be provided at any one of timings at which the order information has not input yet, the order information is being input, and the order information has been input. Preferably, the drawing software is provided after the order information is input. Since a high processing load is imposed on the system if the drawing software is provided and to provide the drawing software is a value-added service to the user who places the order, it is desirable to provide the drawing software after the order is carried out from viewpoints of system operation.

As for providing the drawing software through the electric communication line, there are a case in which the drawing software is transmitted to the user terminal to allow the user to use the drawing software and a case in which the drawing software itself is not transmitted but the function of the drawing software is used by the user by means of the user terminal. In the former case, the pattern data is received from the user terminal. In the latter case, the pattern data is output into the computer system.

Since the conventional system deals with image data (raster graphics), an advanced skill is required to create and process the data. By using the drawing software, by contrast, even a user unfamiliar with computer operation can make an illustration (a drawing, a line drawing, a line art) as if the user easily draws a picture and a user familiar with computer operation can make an elaborated drawing. It is, therefore, possible to facilitate designing a pattern excellent in originality and design and placing an order.

Since commercially available drawing software are expensive and have advanced functions, they are actually not so spread among ordinary users. Further, although many drawing software are present, data compatibility among the software is not ensured or data specifications are not open. Due to this, it is conventionally difficult to apply data of the drawing software to product processing. The present invention can solve these disadvantages by providing dedicated drawing software to each user.

Furthermore, since the conventional system uses raster graphics, the use of the data provided by the user is limited to the use of the data by printing the data using a printer. Since the present invention uses vector graphics, by contrast, the data can be printed by the printer and can be also applied to control over the processing device such as position control by motors.

The input order information and the acquired pattern data are managed by production management means of the computer system. The production management system controls the processing device to give the pattern to the product according to the order information and the pattern information. It is thereby possible to easily produce the product excellent in originality and design using the pattern that the user designs.

Moreover, it is preferable that the order information contains a product reception date and that the production management means determines a data at which the product is to be processed based on the reception date. If the reception date is managed, a production schedule plan can be easily designed. The management of the reception date is particularly preferable if the product is a perishable product such as a decorated cake since an optimum production starting date can be reckoned backward from the reception date.

It is also preferable that the order information contains an email address of a recipient of the product, and that the production management means notifies the recipient of the reception date and a reception location of the product over email. By doing so, even if the orderer and the recipient are different such as a case in which the product is a gift, a notification is transmitted automatically to the recipient so that the recipient can acquire information on the reception in advance.

It is preferable that the production management means enables the recipient of the product to change the reception date and reception location of the product. If so, the recipient can designate a date and a location convenient to the recipient, so that the reception of the product can be made smoothly.

If a plurality of processing devices are present at a plurality of points, it is preferable that the production management means allows the processing device at the point nearest to the reception location of the product to process the product. It is thereby possible to realize produce the product at an appropriate location, and to reduce labor and cost required to deliver the product to the reception location.

The drawing software preferable allows the user terminal to function as follows.

First, the drawing software preferably allows the user terminal to function as graphic input means for allowing the user to make a drawing in a predetermined drawing area. For example, it is preferable that the drawing area is displayed on display means such as a display device, and that the user can make a drawing (a free curve or the like) using a pointing device such as a mouse, a tablet, or a touch panel. Alternatively, a predetermined area on the tablet may be set as the drawing area instead of using the display means. It is thereby possible for the user to intuitively input an intended pattern with good user-friendliness.

Normally, it is difficult to draw a smooth curve freehand. This is because a path moves minutely in a zigzag direction and points deviated from an intended path (outlier points) are often plotted due to the influence of hand shake or the like.

Therefore, the drawing software preferably allows the user terminal to function as curve generation means for acquiring points on a path drawn by the user at predetermined intervals, and for subjecting an acquired sequence of points to curve interpolation to thereby generate a curve. It is thereby possible to correct small zigzags of the path, to eliminate the outlier points, and to obtain the smooth curve approximate to the path that the user originally intends.

“Interval” means herein a time interval or a distance interval. If the time interval is adopted, more points are acquired at parts at which the user carefully draws the path at a lower speed. Therefore, the curve quite approximate to the user drawing path can be obtained. Fewer points are acquired at parts at which the user roughly draws the path at a higher speed, so that the correction effect can be improved. If the distance interval is adopted, it is advantageously possible to uniformly correct the overall graphic. As the distance interval, a line distance between the adjacent acquired points or a path length along the path may be used.

It is further preferable that the drawing software allows the user terminal to function as interval setting means for allowing the user to change an interval for acquiring points. As the interval is wider, the correction effect is higher; however a curve different from the path that the user originally intends may possibly be generated. Conversely, as the interval is narrower, a curve approximate to the path drawn by the user can be obtained; however, the correction effect is lower. Therefore, by allowing the user to change the interval, the balance between the deviation of the curve from the originally intended path and the correction effect can be adjusted by the user and the user-friendliness can be thereby improved.

Furthermore, if the user changes the interval, it is preferable that the curve generation means re-acquires a sequence of points based on the changed interval, subjects the re-acquired sequence of points to curve interpolation, and thereby generates a new curve. By doing so, the user can repeatedly adjust the interval any number of times so as to hold the optimal balance between the deviation of the curve from the intended path and the correction effect once the user makes the drawing in the drawing area. Therefore, the user-friendliness can be further improved.

In this case, the curve generation means preferably displays the generated curve on display means of the user terminal. By doing so, the user can easily check the corrected curve, making it possible to further improve the user-friendliness.

As curve interpolation methods, there are known, for example, an interpolation method using a circular arc, an interpolation method using an nth-degree spline curve, an interpolation method using an nth-degree Bézier curve, and an interpolation method using a clothoid curve. Any arbitrary interpolation method among them can be applied to the present invention. It is more preferably to use the interpolation method using the clothoid curve. Since the clothoid curve has a property that a curvature changes proportionally with a length of the curve. Therefore, it is possible to generate a curve suitable for the control over the processing device.

According to the above-stated drawing software, highly advanced expertise and skill are unnecessary and the pattern can be designed with simple operation.

It is preferable that the drawing software allows the user terminal to function as pattern data generation means for generating and outputting the pattern data from the generated curve. The pattern data thus output is delivered to the software providing means.

If the processing device includes pattern addition means position-controlled by motor driving, the pattern data is preferably data in which an operation command to the motor is described so that the pattern addition means moves according to the curve. It is thereby possible to directly use the data designed by the user for product processing, and to improve productivity.

The present invention can be regarded as any of an order-based production system, an order-based production method, a program, and a recording medium recording the program, all of which include at least part of the above-stated means or procedures. In addition, the means and procedures can be combined as much as possible so as to constitute the present invention.

According to one aspect of the present invention, there is provided an order-based production system that produces a product to a user's order, comprising: a processing device giving a pattern to the product; order acceptance means for allowing a user to input order information; software providing means for providing drawing software that can design the pattern given to the product by vector graphics, to the user who inputs the order information through an electric communication line, and for obtaining pattern data output from the drawing software; and production management means for managing the input order information and the acquired pattern data, and controlling the processing device so as to give the pattern to the product according to the order information and the pattern data.

According to another aspect of the present invention, there is provided an order-based production method for producing a product to a user's order in a computer system connected to a processing device that gives a pattern to a product, comprising the steps of: allowing a user to input order information; providing drawing software that can design the pattern given to the product by vector graphics through an electric communication line, to the user who inputs the order information; acquiring pattern data output from the drawing software; managing the input order information and the acquired pattern data; and controlling the processing device so as to give the pattern to the product according to the order information and the pattern data.

According to still another aspect of the present invention, there is provided a program for producing a product to a user's order by allowing a computer system connected to a processing device that gives a pattern to the product to execute the steps of: allowing a user to input order information; providing drawing software that can design the pattern given to the product by vector graphics through an electric communication line, to the user who inputs the order information; acquiring pattern data output from the drawing software; managing the input order information and the acquired pattern data; and controlling the processing device so as to give the pattern to the product according to the order information and the pattern data.

According to still another aspect of the present invention, there is provided a computer readable recording medium that records a program for producing a product to a user's order by allowing a computer system connected to a processing device that gives a pattern to the product, to execute the steps of: allowing a user to input order information; providing drawing software that can design the pattern given to the product by vector graphics through an electric communication line, to the user who inputs the order information; acquiring pattern data output from the drawing software; managing the input order information and the acquired pattern data; and controlling the processing device so as to give the pattern to the product according to the order information and the pattern data.

### BRIEF DESCRIPTION OF THE DRAWINGS

FIG. 1 is a system block diagram which illustrates the overall configuration of an order-based production system in the first embodiment of the present invention;

FIG. 2 is a block diagram which illustrates the functional configuration of a server;

FIG. 3 is a top view which illustrates an appearance of a processing device;

FIG. 4 is a block diagram which illustrates the hardware configuration of the processing device;

FIG. 5 illustrates the principle of a pentagonal scalar robot;

FIG. 6 is a sequence chart which illustrates one example of an order acceptance processing of the order-based production system;

FIG. 7 illustrates one example of an order screen displayed on a user terminal;

FIG. 8 illustrates one example of the order screen displayed on the user terminal;

FIG. 9 is a block diagram which illustrates the functional configuration of drawing software provided to the user terminal;

FIG. 10 is a flow chart which illustrates one example of a processing flow of the drawing software;

FIG. 11 illustrates one example of an application screen of the drawing software;

FIG. 12 is a illustration for explaining a processing for a diagram which is drawn by the user using a pen tool;

FIG. 13 illustrates one example of an advantage attained if an interval is changed;

FIG. 14 illustrates one example of production management information stored in a database of the server;

FIG. 15 illustrates one example of a production command screen;

FIG. 16 is a system block diagram which illustrates the overall configuration of the order-based production system in the second embodiment of the present invention; and

FIG. 17 illustrates one example of an email sent to a recipient.

### DESCRIPTION OF THE PREFERRED EMBODIMENTS

Exemplary preferred embodiments of the present invention will be described hereinafter in detail with reference to figures.

In this embodiments, examples of applying the present invention to a system for order-based producing an order-made decorated cake will be described. However, the application of the present invention is not limited to the embodiments but the present invention is suitably applied to order-made product order-based production systems of various kinds.

[First Embodiment]

(Overall Configuration of System)

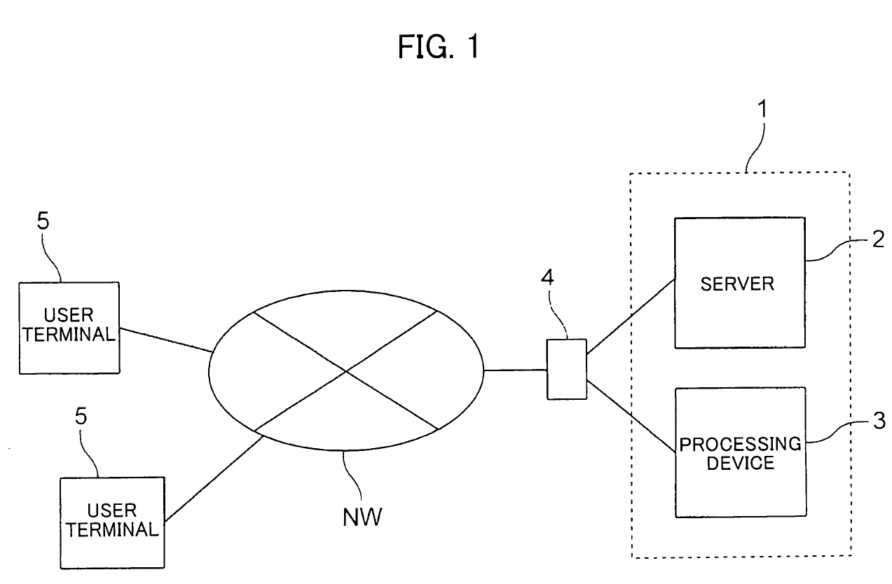

FIG. 1 is a system block diagram which illustrates the overall configuration of an order-based production system in the first embodiment of the present invention.

The order-based production system 1 schematically includes a server 2 and a processing device 3. The server 2 and the processing device 3 are connected to a router 4, and can transmit and receive data to and from each other.

In the order-based production system 1, the server 2 performs processing such as accepting an order, providing of a decoration design function, user management, and production management, and the processing device 3 gives a decoration (adds a pattern) to a cake.

A user can access the server 2 by way of the Internet NW using a user terminal 5, and can order a cake and design the decoration online. A cake produced according to a content of this order is delivered to a destination (e.g., a user's home or a retailer shop) designated by the user. The user can receive the cake at a convenient place.

As can be seen, the system enables the user to order an original decorated cake while the user is at home. On cake production side, since the production side can accept orders across the nation, it is advantageously possible to facilitate increasing clients.

The configuration of each of the constituent elements of the order-based production system 1 will next be described.

(Server)

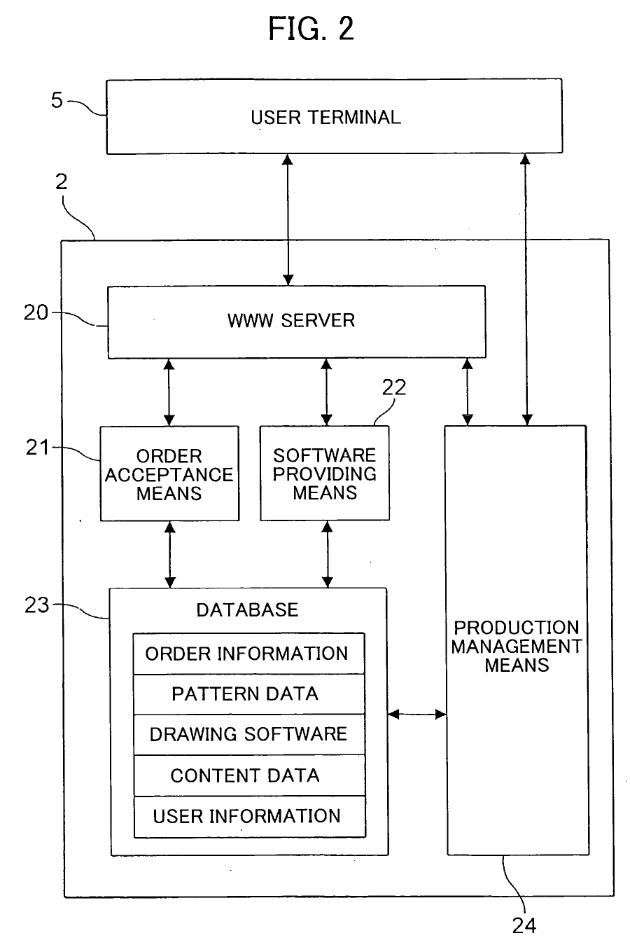

FIG. 2 is a block diagram which illustrates the functional configuration of the server 2.

The server 2 includes functions such as a WWW (World Wide Web) server 20, order acceptance means 21, software providing means 22, a database 23, and production management means 24. The server 2 is a computer system constructed by one or a plurality of computers. The functions of the server 2 are realized by reading programs stored in storage means such as a ROM (Read Only Memory) or a hard disk into a RAM (Random Access Memory), and executing the read programs by a CPU (Central Processing Unit).

The WWW server 20 is a function that provides a WWW service to the user terminal 5 through the Internet. Data of contents provided by the WWW server 20 (e.g., an HTML (Hyper Text Markup Language) file) is stored in the database 23. The user can access the system 1 by inputting a URL (Uniform Resource Locator) of the WWW server 20 using a WWW client software.

The order acceptance means 21 is a function to allow the user to input order information. The software providing means 22 is a function that provides drawing software which can design a decoration pattern of the cake to the user through the Internet. An order information input processing and the provision of drawing software are performed through the WWW server 20. Input order information and pattern data output from the drawing software are made associated with each other and stored in the database 23. The database 23 further stores the drawing software, user information, and the like.

The production management means 24 takes on a function of general management processing including user management and production management. The production management means 24 manages (registers, updates, deletes or the like) the order information and the pattern data stored in the database 23. In addition, the production management means 24 transmits the pattern data to the processing device at appropriate timing so as to give the pattern to the cake according to the order information and the pattern data, and controls the processing device 3.

(Processing Device)

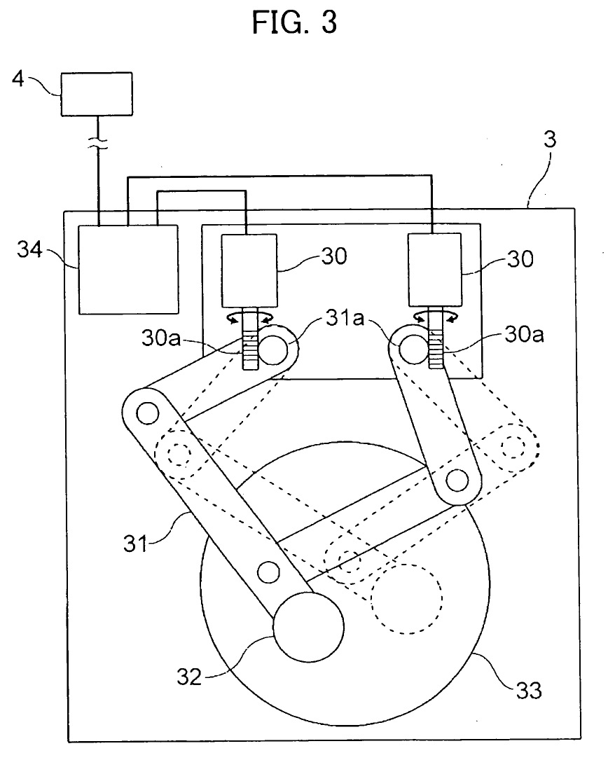

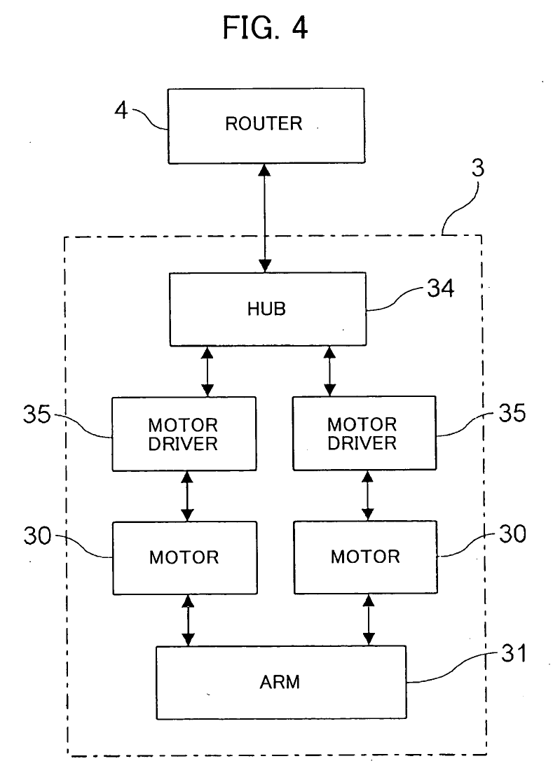

FIG. 3 is a top view which illustrates the appearance of the processing device 3. FIG. 4 is a block diagram which illustrates the hardware configuration of the processing device 3.

As shown in FIGS. 3 and 4, the processing device 3 is a cake marker robot (control target device) provided with a motor-driven arm.

The processing device 3 schematically includes two motors 30 and an arm 31 driven by the motors 30. The motors 30 are connected to a hub 34 through motor drivers 35, respectively. A driving force of each motor 30 is transmitted to the arm 31 through a worm gear constructed by a worm 30a provided on a motor shaft and a worm wheel 31a provided on a proximal end portion of the arm 31.

A syringe pump 32 is attached to a tip end of the arm 31. The syringe pump 32 is pattern adding means a position of which is controlled by the motor, squeezes chocolate cream, fresh cream, or the like on a cake put on a cake mount 33, and that gives a pattern to the cake. The syringe pump 32 is switched to a squeeze mode or a stop mode synchronously with an operation of the arm 31. Squeeze and stop operations of the syringe pump 32 are controlled in timing with movement of the arm 31.

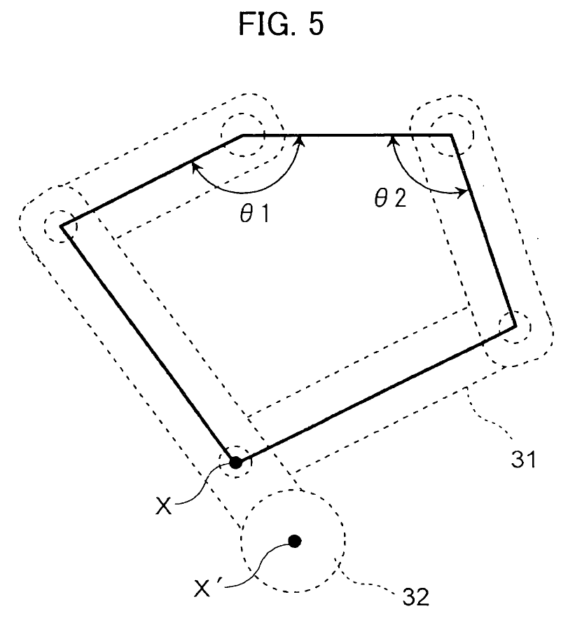

The position of the syringe pump 32 is controlled using the principle of a pentagonal scalar robot. As shown in FIG. 5, the pentagonal scalar robot is constructed by a pentagonal arm. The pentagonal scalar robot has the following characteristics. If motor rotational angles θ1 and θ2 are set, a coordinate of a work point X is univocally determined. Conversely, if the coordinate of the work point X is set, the motor rotational angles θ1 and θ2 are univocally determined. In other words, by appropriately controlling the rotational angles of the two motors 30, the position of a point X′ of the syringe pump 32 can be controlled.

The processing device 3 is connected to the router 4 through the hub 34. When the processing device 3 receives the pattern data from the server 2, the motors 30, the arm 31, and the syringe pump 32 of the processing device 3 operate, thereby decorating the cake.

(Processing Flow)

One example of a processing flow of the order-based production system constituted as stated above will next be described.

A program that realizes the processing of the system is an event-driven program and executes a corresponding processing according to an event such as user's input. Therefore, the processing flow to be described below is only one typical flow of the programs.

(Order Acceptance Processing)

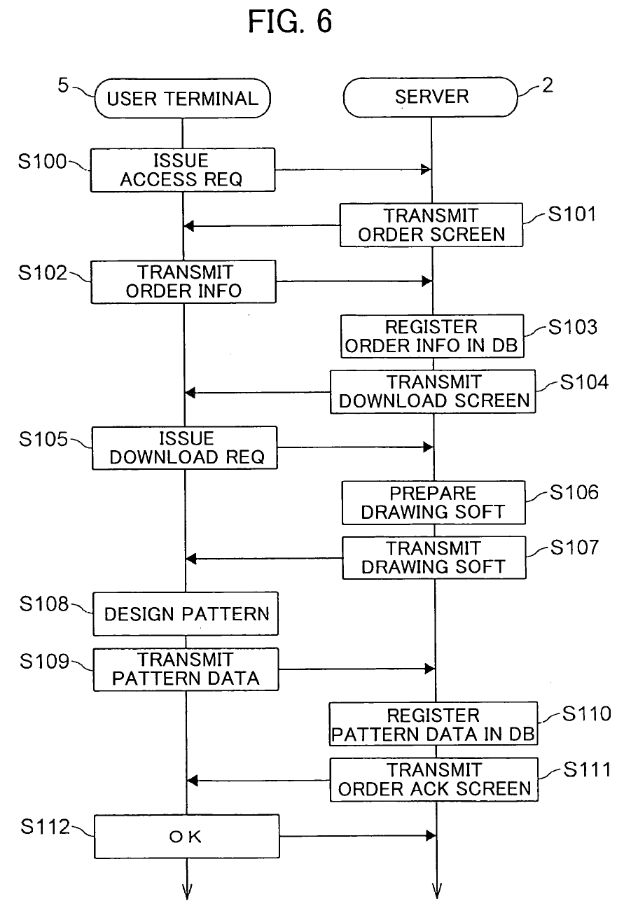

FIG. 6 is a sequence chart which illustrates one example of an order acceptance processing of the order-based production system 1 in the first embodiment.

The user who is to place an order starts WWW client software using the user terminal 5. The user inputs a URL of a service provided by the system 1, and accesses the server 2 (in a step S100).

When receiving an access request from the user terminal 5, the server 2 activates the order acceptance means 21. The order acceptance means 21 creates an HTML file for a form screen (an order screen) for inputting order information, and transmits the created HTML file to the user terminal 5 through the WWW server 20 (in a step S101). As a result, the order screen is displayed on a display of the user terminal 5.

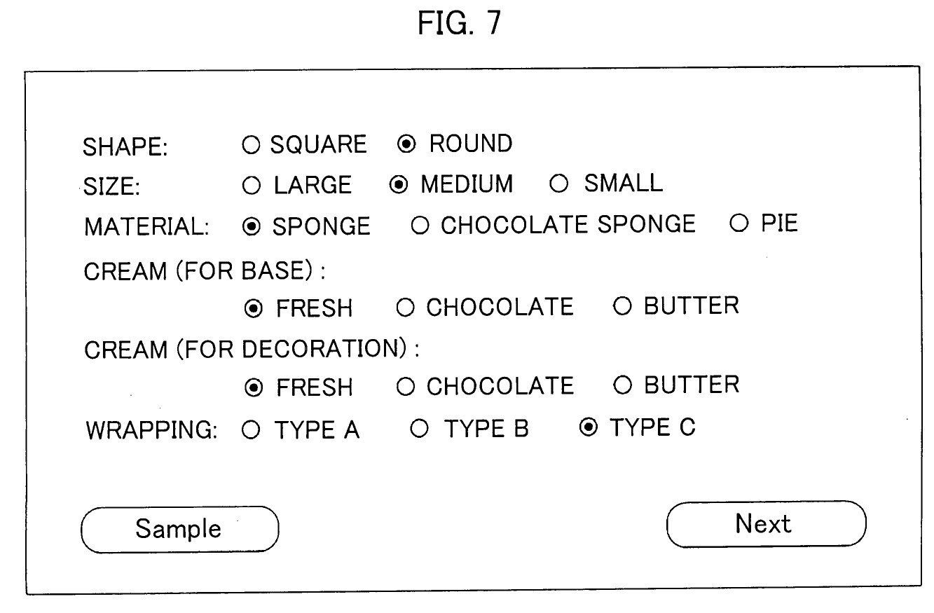

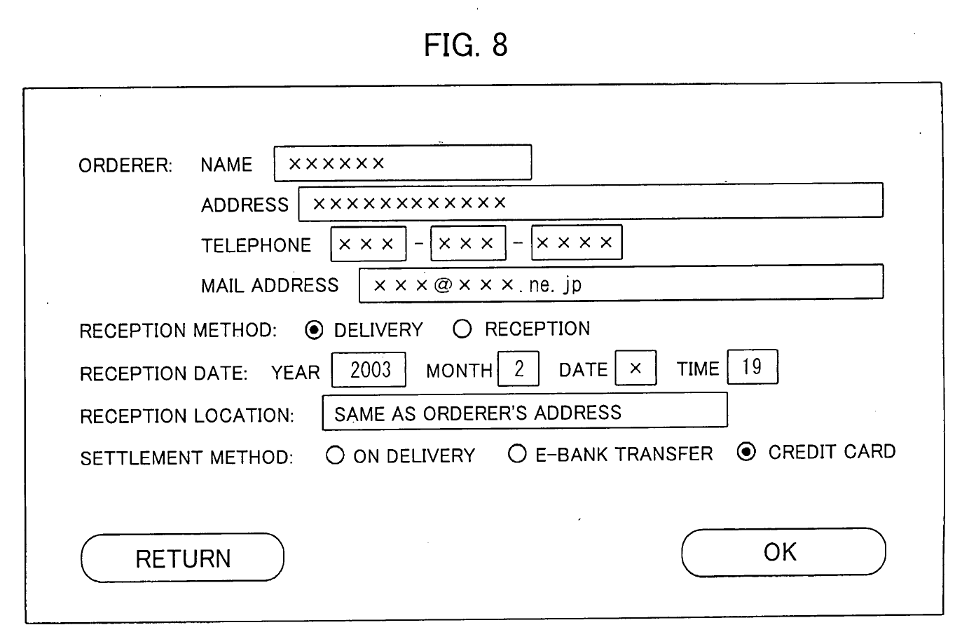

FIGS. 7 and 8 illustrate one example of the order screen displayed on the display of the user terminal 5.

On the order screen shown in FIG. 7, the user can input basic specifications of the cake including a shape of the cake, a size (dimension) of the cake, a type of the cake such as a material of the cake and a base cream of the cake, a type of a cream used for decoration, and a type of wrapping. In the example of FIG. 7, the user selects “round” as the shape, “medium” as the size, “sponge” as the material, “fresh cream” as the base cream, “fresh cream” as the decorated cream, and “type C” as the wrapping.

If the user presses a “Sample” button after inputting these basic specifications, a sample image of the cake is displayed. By viewing this sample image, the user can check the basic specifications of the cake.

If pressing a “Next” button after completing with the input of the basic specifications, the order screen shown in FIG. 8 appears. On this order screen, the user inputs information including a name, an address, a telephone number, an email address, a reception method, a reception date (delivery date), a reception destination (delivery destination), a settlement method, and the like of an orderer (the user). In the example shown in FIG. 8, the user selects “delivery to the address of the user's house” as the reception method, and “credit card settlement” as the settlement method.

When the user presses an “OK” button after inputting these pieces of information, the order information is transmitted to the server 2 (in a step S102). The order information is registered in the database 23 by the order acceptance means 21 (in a step S103). At this time, the order acceptance means 21 may perform a processing for asking the user to acknowledge the order information.

After the order information is normally input (that is, the order is acknowledged), the software providing means 22 provides the user with the drawing software. This drawing software is software that can design the decoration pattern given to the cake by vector graphics.

The software providing means 22 first creates an HTML file for a software download screen, and transmits the created HTML file to the user terminal 5 through the WWW server 20 (in a step S104). On the download screen, the user can select a software of a version suited to the environment (such as a type of an operating system and a version) of the user terminal 5. If the user presses a download button on the download screen, a download request is transmitted to the server 2 (in a step S105).

Upon receiving the download request, the software providing means 22 prepares the drawing software to be provided to the user (in a step S106). Specifically, the drawing software of the version designated by the user is selected from among those stored in the database 23, and creates an initial setting file for the drawing software.

The initial setting film is a file that defines an operation of the drawing software and a setting of a GUI (Graphical User Interface). The software providing means 22 creates the initial setting file so that the shape and size of the cake coincide with a shape and a size of a drawing area of the drawing software, respectively, while referring to the basic specifications of the cake included in the order information. Preferably, the software providing means 22 may change the drawing area or a graphics color in accordance with the type of the material and that of the cream. By thus appropriately changing the setting of the drawing software in accordance with the basic specifications of the cake, it is possible to facilitate designing the pattern by the user.

After preparing the drawing software and the initial setting file, the software providing means 22 transmits the prepared drawing software and the initial setting file to the user terminal 5 (in a step S107). After completing downloading the software and the file, the user terminal 5 starts the drawing software, and is ready for designing a decoration pattern (in a step S108).

By using the drawing software, even the user unfamiliar with computer operation can easily create an illustration (a drawing) as if the user draws a picture with familiar tools. In addition, the user familiar with drawing can create an elaborated drawing. Therefore, it is possible to easily design a pattern excellent in originality and design. In this embodiment, the dedicated drawing software is employed so as to further improve user's user-friendliness, which will be described later in detail.

After the pattern is designed using the drawing software, the pattern data output from the drawing software is transmitted to the server 2 (in a step S109). The pattern data is registered in the database 23 by the software providing means 22 (in a step S110).

Finally, an acknowledgement screen for acknowledging contents of the order information and pattern data input by the user is transmitted to the user terminal 5 (in a step Sill), thereby acknowledging whether there is no error or change in the order information and the pattern data (in a step S112). Alternatively, an order content acknowledgement email maybe transmitted to the email address of the user. The order acceptance processing is thus completed.

(Drawing Software)

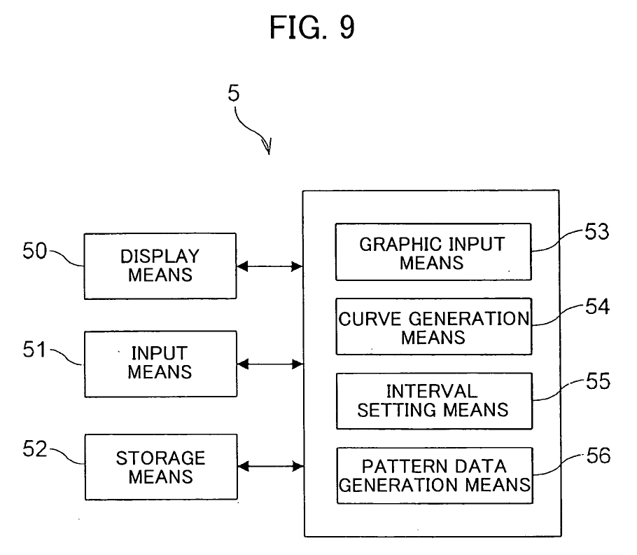

FIG. 9 is a block diagram which illustrates the functional configuration of the drawing software provided to the user terminal.

When the drawing software is read and executed by the user terminal 5, the drawing software cooperates with hardware resources such as display means 50, input means 51, and storage means 52 to allow the user terminal 5 to function as graphic input means 53, curve generation means 54, interval setting means 55, and pattern data generation means 56.

The user terminal 5 is constructed by a general-purpose personal computer. A display, a touch panel, and the like correspond to the display means 50. A mouse, a tablet, and the like correspond to the input means 51. A memory, a hard disk, and the like correspond to the storage means 52.

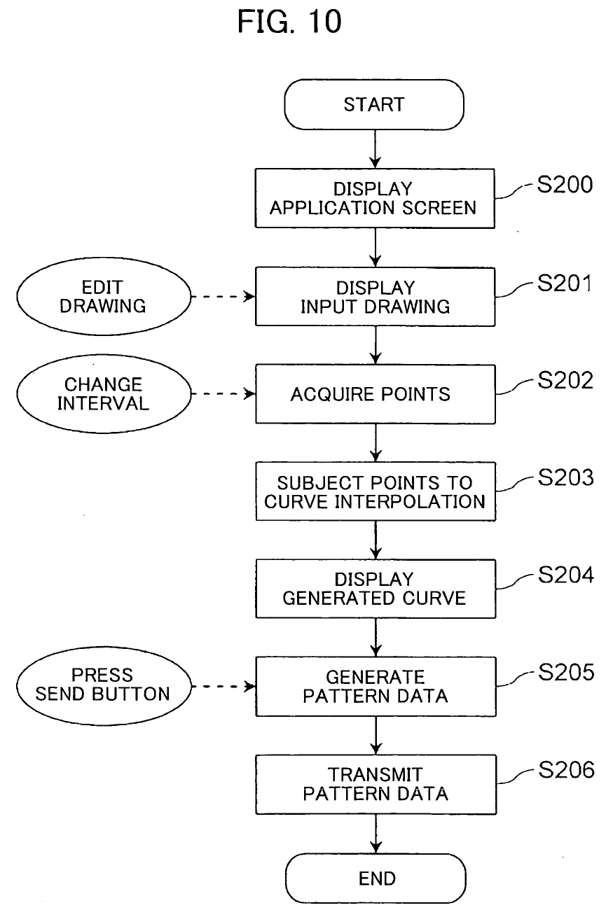

FIG. 10 is a flow chart which illustrates one example of a processing flow of the drawing software. Blocks indicated by ellipses on the left of the flow chart represent respective events made by the user.

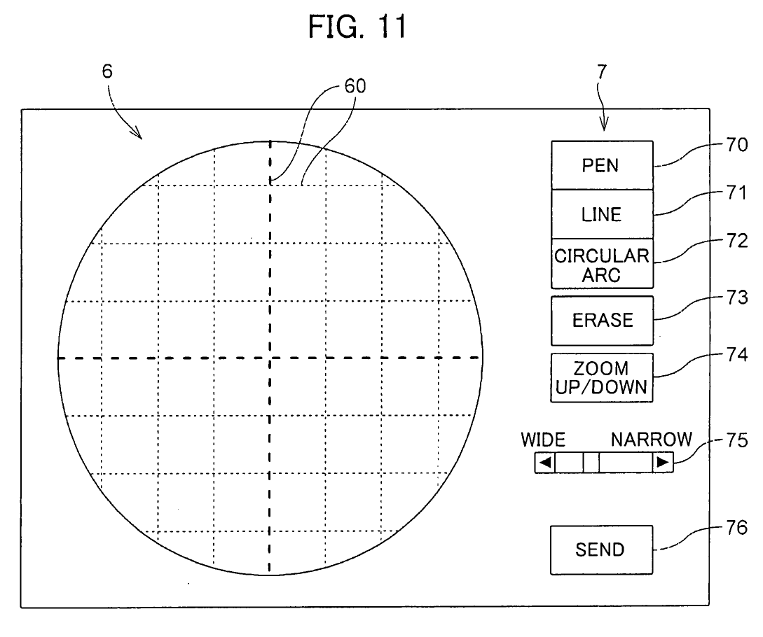

When the drawing software is started, the graphic input means 53 displays an application screen on the display means 50 (in a step S200). As shown in FIG. 11, the application screen includes a drawing area 6 and a plurality of tools 7.

The drawing area 6 is a part that functions as a canvas on which a drawing is made. A shape and a size of the drawing area 6 reflect in the contents set by the initial setting file. Namely, in this embodiment, the drawing area 6 corresponding to the cake in the “round” shape with the “medium” size as designated by the user is displayed. Since the drawing area varies with the shape and size of the cake, the pattern can be easily designed and a design error such as protrusion of the pattern from the cake can be prevented.

As tools for making the drawing, a pen tool 70, a line tool 71, and a circular arc tool 72 are prepared. The pen tool 70, the line tool 71, and the circular arc tool 72 provide functions for drawing a free curve, a straight line, and a circle or a circular arc, respectively. The user selects one of these tools, inputs a path or points in the drawing area 6, and can thereby make the desired drawing in the drawing area 6.

The user can thus input the decoration pattern with good user-friendliness as if the user easily draws a picture with familiar tools such as a pen. In addition, since grid lines 60 are displayed in the drawing area 6, the grid lines 60 can be used as a guide to consideration of a shape, a size, an arrangement, and the like of the drawing, thereby facilitating pattern designing.

If the pen tool 70 is selected, the graphic input means 53 displays a path drawn by the user in the drawing area 6 as a free curve (in a step S201). If the line tool 71 is selected, a line connecting two points plotted by the user is displayed in the drawing area 6. If the circular arc tool 72 is selected, a circle or a circular arc defined by two or three points plotted by the user is displayed in the drawing area 6. The graphic input means 53 writes data of the drawing in the storage means 52.

If an erasure tool 73 is used, the drawing made can be erased. If the drawing input fails, the user can re-input the drawing any number of times. If an zoom up/down tool 74 is used, a display magnification of the drawing area 6 can be zoomed up or down. Therefore, the user can easily draw even a complicated graphic.

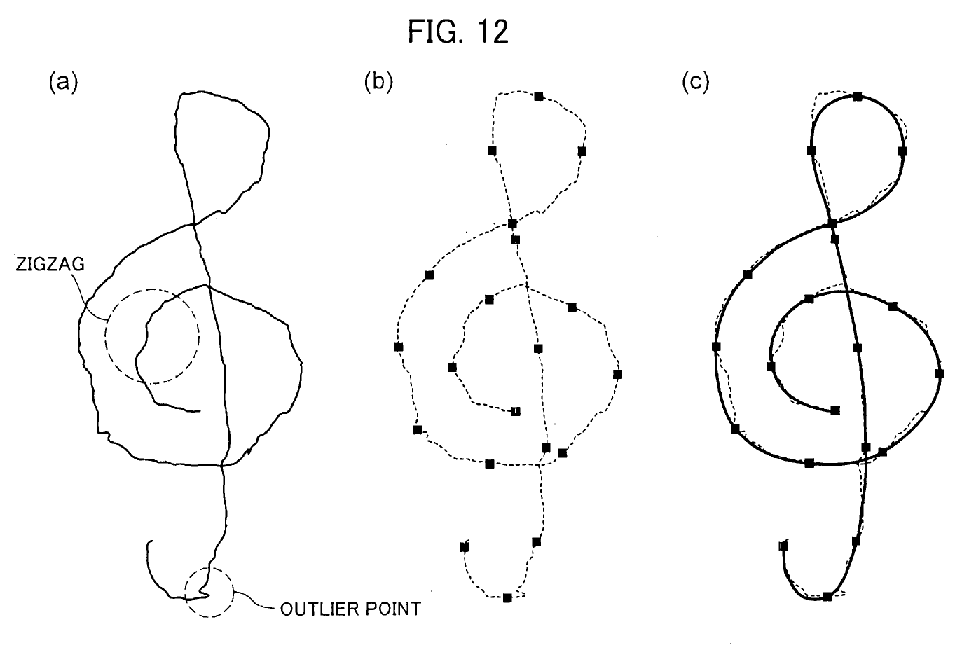

FIG. 12 illustrates one example of the drawing made using the pen tool 70. In FIG. 12, “a G clef” is drawn.

Normally, it is difficult to draw a smooth curve freehand. The path moves minutely in a zigzag direction and points deviated from an intended path (outlier points) are often plotted due to the influence of hand shake or the like. Even if the syringe pump 32 of the processing device 3 is actuated according to such a path, the cake cannot be beautifully decorated. Further, as for the path having many zigzag points and many outlier points, it is difficult to design a motor acceleration, an unexpected waviness or vibration of the arm 31 of the processing device 3 may possibly occur, and a speed of each motor cannot be accelerated. As a result, deterioration of productivity disadvantageously occurs.

To prevent the disadvantage, the curve generation means 54 acquires points on the path drawn by the user at predetermined intervals (in a step S202). FIG. 12(b) illustrates a manner of the acquisition. In FIG. 12(b), the path drawn by the user is indicated by a broken line and the points acquired (acquired points) are indicated by rectangles. In this embodiment, the acquired points are selected at certain time intervals based on a speed at which the user draws the path. Accordingly, more acquired points are selected at parts at which the user carefully draws the path at a lower speed (the acquired points are dense) whereas fewer acquired points are selected at parts at which the user roughly draws the path at a higher speed (the acquired points are sporadic).

Next, the curve generation means 54 subjects the acquired sequence of points to curve interpolation to generate a curve (in a step S203). FIG. 12(c) illustrates a manner of the curve interpolation. In FIG. 12(c), the curve generated by the curve interpolation is indicated by a solid line to be superposed on the path (indicated by the broken line) drawn by the user and the acquired points (indicated by the rectangles). FIG. 12C indicates that the small zigzags of the path are corrected, the outlier points are eliminated, and that the smooth curve approximate to the path that the user originally intends to draw is obtained.

In this embodiment, a clothoid curve is used for the curve interpolation. The clothoid curve has a property that a curvature changes proportionally with a length of the curve. Therefore, the change of the acceleration in a lateral direction of the arm 31 of the processing device 3 becomes continuous, making it possible to smoothly move a heavy matter or a matter having a high moment of inertia at a high speed. Furthermore, by using the clothoid curve, it is advantageously possible to prevent the arm from generating unexpected waviness or vibration. Besides, since the curve never fails to pass the acquired sequence of points, the curve approximate to the path drawn by the user can be obtained.

The curve generation means 54 displays the curve thus generated in the drawing area 6 in the manner shown in FIG. 12(c) (in a step S204). The user can thereby easily check the corrected curve, thereby improving the user-friendliness.

At this moment, by operating an interval setting tool 75, the user can change an interval for obtaining points. As shown in FIG. 11, the interval setting tool 75 includes a slider member. As the slider member is moved more rightward, the interval is narrower. As the slider member is moved more leftward, the interval is wider. It is noted that the function of the interval setting tool 75 is realized by the interval setting means 55 (see FIG. 9).

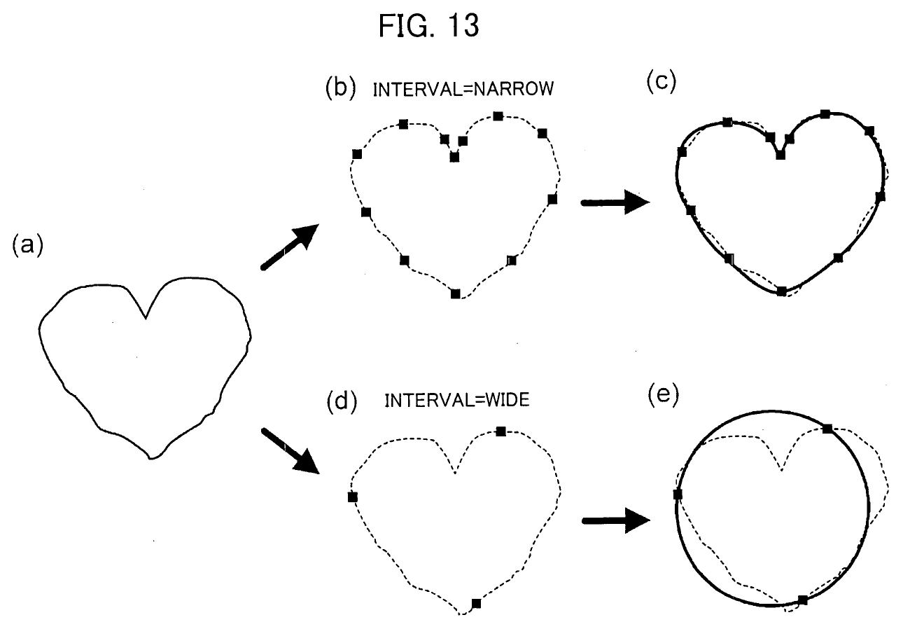

FIG. 13 illustrates one example of an effect attained when the interval is changed. The narrower the interval is, the more the acquired points become (see (b)). Accordingly, a curve (see (c)) approximate to a path (see (a)) drawn by the user can be obtained; however, a correction effect is lower. On the other hand, the wider the interval is, the fewer the acquired points become (see (d)). Accordingly, the correction effect is higher; however, a curve (see (e)) different from the path drawn by the user may possibly be generated. In this embodiment, by allowing the user to change the interval, the balance between the deviation from the intended path and the correction effect can be adjusted by the user and the user-friendliness is thereby improved.

If the user changes the interval, the processing in the steps S202 to S204 is re-executed to the drawing that is now being edited. Namely, the curve generation means 54 re-acquires a sequence of points based on the changed interval, subjects the re-acquired sequence of points to clothoid curve interpolation to generate a new curve, and displays the generated curve in the drawing area 6.

Hence, the user can repeatedly adjust the interval any number of times so as to hold the optimal balance between the deviation of the curve from the intended path and the correction effect once the user makes the drawing in the drawing area 6.

In the drawing area 6, the user can make a plurality of paths. If the user makes a plurality of paths, the above-stated curve interpolation is performed for each path and multiple clothoid curves are generated.

Thereafter, if the user presses a send button 76, the pattern data generation means 56 (see FIG. 9) generates pattern data based on the generated curve (in a step S205). The pattern data in this embodiment is data in which operation commands to the motors 30 are described so that the syringe pump 32 of the processing device 3 moves according to the curve.

First, the pattern data generation means 56 calculates a moving coordinate of the syringe pump 32 at two-millisecond intervals while considering a speed and an acceleration at which the motors 30 and the arm 31 are stable. Based on the principle of the pentagonal scalar robot, the pattern data generation means 56 calculates the motor rotational angles θ1 and θ2 from X and Y coordinate values on each moving coordinate. Each of two-millisecond angle data is stored in a CSV file format, thus providing the pattern data. Other control commands and the like are often added to the pattern data.

The pattern data generation means 56 then transmits (outputs) the generated pattern data to the server 2 (in a step S206). As described, the pattern data is stored in the database 23 of the server 2 by the software providing means 22 of the server 2.

In this embodiment, a pattern created by the user using the drawing software is converted to motor operation commands and output as the pattern data. It is, therefore, possible to directly use the data designed by the user to product processing, and to improve the productivity.

(Production Management Processing)

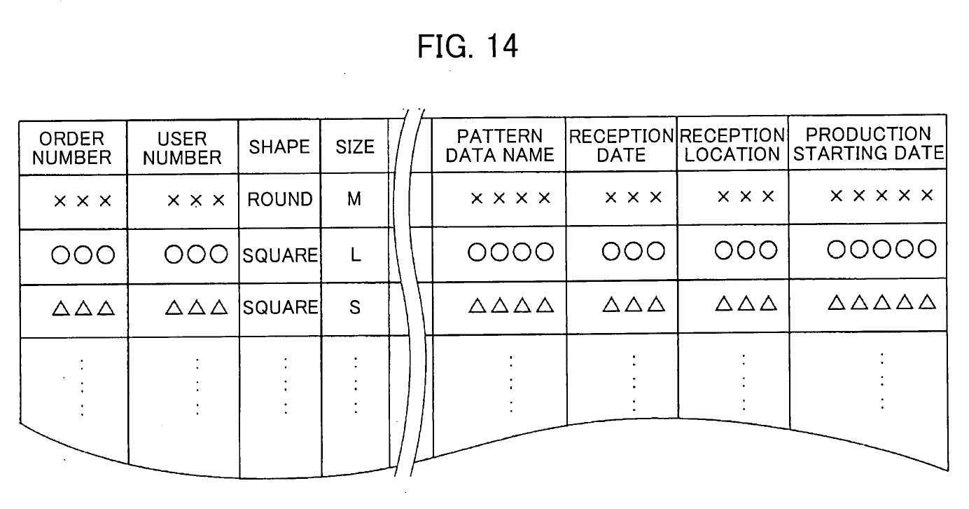

FIG. 14 illustrates one example of production management information stored in the database 23 of the server 2. This production management information is generated, updated, and managed by the production management means 24.

The production management information includes an order number, a user number, the basic specifications of the cake, a pattern data name, a reception date, a reception location, a production starting date, and the like. The production management means 24 calculates the production starting date that is a date when the cake is to be processed based on the reception date and the reception location (i.e., reckons backward the production starting date) in consideration of time required for delivery, a best-before date of the cake, and the like as well as an operating condition of the processing device 3. Since the cake is perishable, the cake cannot be made beforehand and it is difficult to make production planning. However, the system can calculate the optimal production starting date, and thereby realize efficient production.

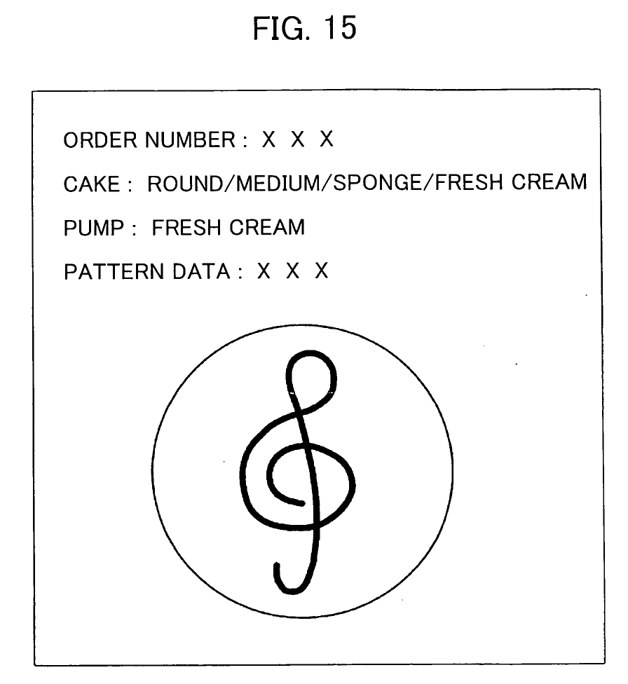

On the production starting date, the production management means 24 reads the basic specifications of the cake from the production management information, and outputs a production command screen for notifying an operator of the contents of the cake to be produced on the display. FIG. 15 illustrates one example of the production command screen. In FIG. 15, an order number, a type of a cake to be set on the cake mount, a type of a cream to be filled into the syringe pump, and a pattern data preview image are displayed. The operator can check contents of the operation, making it possible to reduce operation error and to realize efficient production.

Upon detecting that the cake and the syringe pump are set, the production management means 24 reads the pattern data from the database 23 and transmits the pattern data to the processing device 3. The hub 34 of the processing device 3 specifies the control target motor 30 based on the pattern data, and transmits the pattern data to the motor driver 35 for the motor 30. The motor driver 35 drives the motor 30 to rotate based on the pattern data. As a result, the syringe pump 32 attached to the tip end portion of the arm 31 performs a required operation and decorates a surface of the cake.

The decorated cake is carried to a wrapping step in which the cake is given wrapping designated by the user. In this step, similarly to the above, a wrapping command screen is output from the production management means 24. It is, therefore, possible to reduce operation error.

The production management means 24 also has a function of making a production prediction based on the production management information. Specifically, the production management means 24 calculates the type and number of cakes to be produced, amounts of necessary creams and the other materials, and the like for a predetermined periodical unit such as a day-basis, a week-basis, or a month-basis. The production prediction information thus calculated is output to the display, the printer, or the like, or transmitted to a terminal located in a material purchase department. According to this system, the necessary materials are automatically predicted and calculated based on the order information, so that efficient supply of materials and efficient production can be realized.

As stated so far, according to the constitution and method in this embodiment, the user can easily order the order-made original cake online.

Furthermore, since the drawing software is provided to the user who places an order, the user can easily perform the operation of designing the decoration pattern of the cake using the drawing software dedicated to the system.

By using the drawing software, even the user unfamiliar with computers can make a drawing as if the user easily draws a picture with familiar tools such as a pen and the user familiar with computers can make elaborated drawing. As compared with the conventional system, it is possible to facilitate designing the pattern excellent in originality and design and placing an order.

Besides, since the dedicated drawing software specific to the designing of the decoration of the cake is provided to the user, the user can easily set the pattern using the drawing software with excellent user-friendliness, as compared with the general-purpose drawing software commercially available.

Moreover, the constitution and the method in this embodiment are advantageous to the production side similarly to the user side.

Namely, since the dedicated drawing software is provided, a problem of data compatibility or the like can be avoided. In addition, since the vector graphics is used, the data generated by the user can be applied to the control over the processing device 3 such as the position control performed by the motor. In this embodiment, in particular, the data (pattern data) in which the motor operation command is described is output from the drawing software, the data can be directly utilized for the processing of the cake and the productivity can be thereby improved.

Further, since the production management is automatically made based on the order information, it is possible to efficiently produce original products and to reduce cost.

[Second Embodiment]

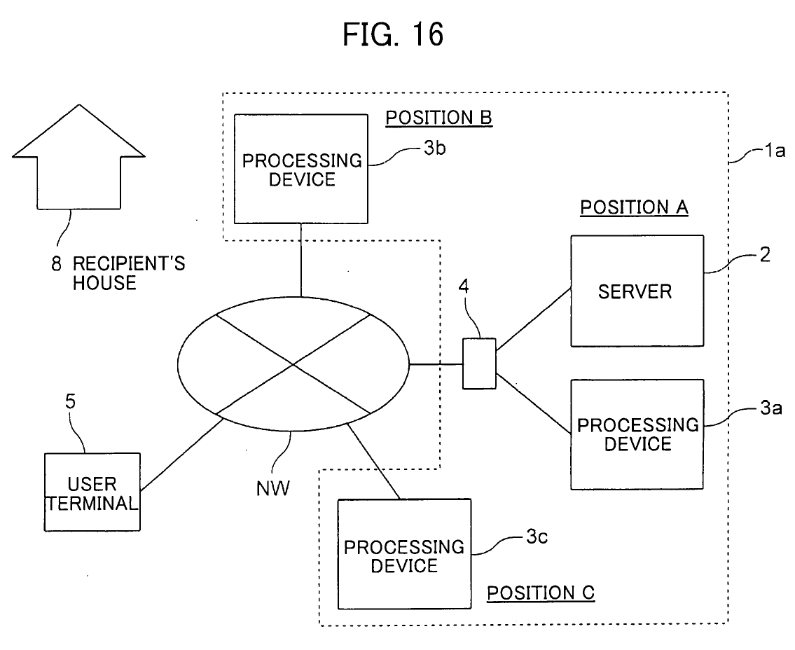

FIG. 16 is a system block diagram which illustrates the overall configuration of the order-based production system in the second embodiment of the present invention.

The configuration characteristic of the order-based production system 1a in this embodiment will be described and the same constituent elements as those in the first embodiment will not be described herein in detail.

The order-based production system 1a schematically includes the server 2 and processing devices 3a, 3b, and 3c. Among these constituent elements, the server 2 and the processing device 3a are disposed at the same position A and connected to the router 4. The processing device 3b is disposed at a position B, and the processing device 3c is disposed at a position C. The server 2, and the processing devices 3a, 3b, and 3c can transmit and receive data to and from one another through electric communication lines such as LAN or the Internet NW. It is noted that the number of positions at which the processing devices are disposed is not limited to three but may be two or may be four or more.

In the order-based production system 1a, the server 2 collectively performs processing of accepting an order, providing of the decoration design function, the user management, the production management, and the like. The cake the order of which is accepted by the server 2 can be produced by any of the processing devices 3a to 3c disposed at the respective positions.

In this embodiment, in the order acceptance processing, information such as a name, an address, a telephone number, an email address, and the like of a recipient of the cake can be also input to the order information. If the recipient is designated, the produced cake is delivered to the recipient. It is thereby possible that, for example, a grandfather who lives at the countryside makes a design of a cake and sends the cake to his grandson who lives in Tokyo as a gift. Thus, the original cake can be used as a gift.

When the order acceptance processing is finished, the production management means 24 checks the order information stored in the database 23. If the recipient's email address is included in the order information, the production management means 24 notifies the recipient of information as to the reception of the cake over email.

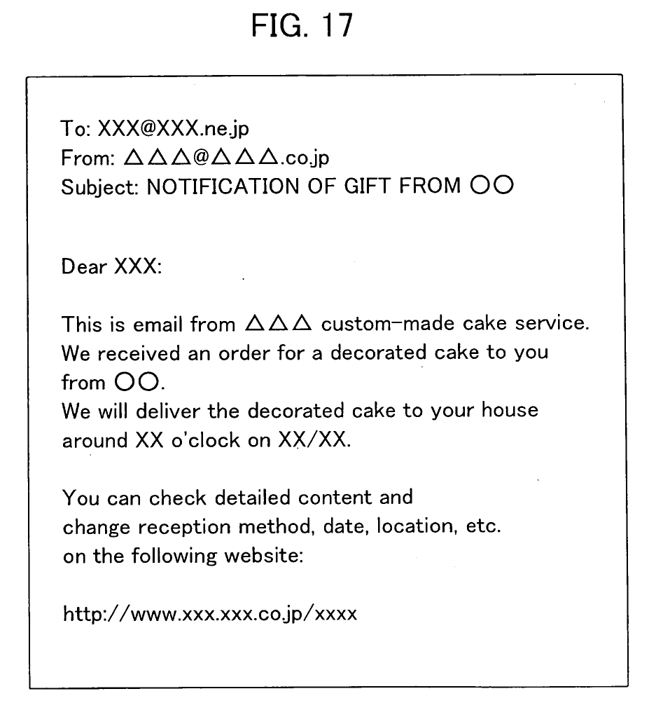

FIG. 17 illustrates one example of the email sent to the recipient. As shown in FIG. 17, this email contains information such as the orderer (sender) of the cake, the reception date, the reception location, the reception method, and the like. By reading this mail, the recipient can be informed of necessary information for reception of the cake in advance. In case of an ordinary door-to-door parcel delivery service, the recipient cannot be informed of the necessary information for reception and delivery may possibly delay due to absence of the recipient to may be possibly past a best-before date or perished. According to this system, by contrast, the recipient can be notified of the information in advance over email, so that such disadvantages can be prevented.

Further, this email contains a URL of the order-based production system 1a. By accessing this URL using the WWW client software, the user (recipient) can check more detailed reception information, changes the reception date, reception location, and method, and do the other things. If the recipient changes the reception date or the like, the production management means 24 reflects a changed content in the production management information stored in the database 23. With such a construction, the recipient can designate convenient date, location, and method, making it possible to smoothly receive the cake. As the reception method, it is possible to designate reception of the cake at a cake shop or a convenience store besides the delivery.

If the processing devices are sporadically disposed at a plurality of positions as described in this embodiment, the production management means 24 refers to the reception location contained in the production management information, and performs production management so that the processing device located at the nearest position to the reception location can process the cake. For example, if a recipient house 8 is designated as the reception location in FIG. 16, the position B nearest to the recipient house 8 is selected as a production position.

On the production starting date of the cake, the production management means 24 issues a production command to the processing device 3b disposed at the position B. It is thereby possible to realize the production of the cake at an arbitrary position, and to reduce labor and cost required to deliver the cake to the reception location.

The examples that embody the present invention have been described so far while referring to the first and second embodiments. However, the present invention is not limited to these embodiments and various changes and modifications can be made within the scope of the technical idea of the present invention.

For example, as initially described, the present invention is not limited to the system that produces original cakes to a user's order but can be appropriately applied to order-based production systems for order-made products of various kinds. The present invention can be, for example, applied to a system that embroiders original patterns on clothes, socks, and the like, a system that carves or prints original patterns on wooden or metallic household articles, furniture, and the like, and systems that process original patterns on various order-made products.

Furthermore, in the embodiments stated above, the drawing software is downloaded to the user terminal. Alternatively, while the drawing software is held in the server, only the function of the drawing software may be suitably used by the user terminal similarly to an ASP (Application Service Provider).

What is claimed is:

1. An order-based production system that produces a product to a user's order, comprising:
a processing device giving a pattern to the product;
order acceptance means for allowing a user to input order information;
software providing means for providing drawing software that can design the pattern given to the product by vector graphics, to the user who inputs the order information through an electric communication line, and for obtaining pattern data output from the drawing software; and
production management means for managing the input order information and the acquired pattern data, and controlling the processing device so as to give the pattern to the product according to the order information and the pattern data.

2. An order-based production system according to claim 1, wherein
the drawing software allows a user terminal to function as:
graphic input means for allowing the user to make a drawing in a predetermined drawing area;
curve generation means for acquiring points on a path drawn by the user at predetermined intervals, and for subjecting the acquired sequence of points to curve interpolation to thereby generate a curve; and
pattern data generation means for generating and outputting the pattern data from the generated curve.

3. An order-based production system according to claim 2, wherein
the processing device comprises pattern addition means position-controlled by motor driving, and
the pattern data is data in which an operation command to the motor is described so that the pattern addition means moves according to the curve.

4. An order-based production system according to claim 2, wherein
the drawing software allows the user terminal to function as interval setting means for allowing the user to change an interval for acquiring the points.

5. An order-based production system according to claim 4, wherein
if the interval is changed, the curve generation means re-acquires a sequence of points based on the changed interval, subjects the re-acquired sequence of points to curve interpolation to thereby generate a new curve.

6. An order-based production system according to claim 2, wherein
the curve generation means displays the generated curve on display means of the user terminal.

7. An order-based production system according to claim 2, wherein
the curve generation means subjects the acquired sequence of points to clothoid curve interpolation.

8. An order-based production system according to claim 1, wherein
the order information contains a reception date of the product, and
the production management means determines a date at which the product is to be processed based on the reception date.

9. An order-based production system according to claim 1, wherein
the order information contains an email address of a recipient of the product, and
the production management means notifies the recipient of a reception date and a reception location of the product over email.

10. An order-based production system according to claim 1, wherein
the production management means allows a recipient of the product to change a reception date and a reception location of the product.

11. An order-based production system according to claim 1, wherein
if a plurality of the processing devices are present at a plurality of positions, respectively, the production management means makes the processing device at the position nearest to a reception location of the product to process the product.

12. An order-based production system according to claim 1, wherein
the product is a decorated cake, and the pattern is a decoration given to the decorated-cake.

13. An order-based production system according to claim 12, wherein
the order acceptance means allows the user to input or select at least one of a size of the cake, a shape of the cake, a type of the cake, a material used for the decoration, and a type of wrapping.

14. An order-based production method for producing a product to a user's order in a computer system connected to a processing device that gives a pattern to a product, comprising the steps of:
allowing a user to input order information;
providing drawing software that can design the pattern given to the product by vector graphics through an electric communication line, to the user who inputs the order information;
acquiring pattern data output from the drawing software;
managing the input order information and the acquired pattern data; and
controlling the processing device so as to give the pattern to the product according to the order information and the pattern data.

15. A program for producing a product to a user's order by allowing a computer system connected to a processing device that gives a pattern to the product to execute the steps of:
allowing a user to input order information;
providing drawing software that can design the pattern given to the product by vector graphics through an electric communication line, to the user who inputs the order information;
acquiring pattern data output from the drawing software;
managing the input order information and the acquired pattern data; and
controlling the processing device so as to give the pattern to the product according to the order information and the pattern data.

16. A computer readable recording medium that records a program for producing a product to a user's order by allowing a computer system connected to a processing device that gives a pattern to the product, to execute the steps of:
allowing a user to input order information;
providing drawing software that can design the pattern given to the product by vector graphics through an electric communication line, to the user who inputs the order information;
acquiring pattern data output from the drawing software;
managing the input order information and the acquired pattern data; and
controlling the processing device so as to give the pattern to the product according to the order information and the pattern data.
